(19) United States
(12) Patent Application Publication
(10) Pub. No.: US 2025/0162318 A1
(43) Pub. Date: May 22, 2025

(54) LIQUID EJECTION HEAD AND LIQUID EJECTION APPARATUS

(71) Applicant: CANON KABUSHIKI KAISHA, Tokyo (JP)

(72) Inventors: TAKUYA IWANO, Tokyo (JP); KOJI TACHIBANA, Kanagawa (JP)

(21) Appl. No.: 18/947,093

(22) Filed: Nov. 14, 2024

(30) Foreign Application Priority Data
Nov. 22, 2023 (JP) 2023-198338

(51) Int. Cl. B41J 2/14; B41J 2/16

(52) U.S. Cl. CPC B41J 2/1433; B41J 2/14201; B41J 2/162; B41J 2/1623; B41J 2002/14306; B41J 2002/14411

(57) ABSTRACT

To provide a liquid ejection head whose resistance to the deformation of a support member has been improved. The liquid ejection head comprises: a first substrate having a first surface in which an ejection port configured to eject liquid is provided; a support member joined to the first surface of the first substrate and provided with an opening surrounding an area in which the ejection port in the first substrate is provided; and a second substrate joined to a second surface on the opposite side of the first surface of the first substrate. An area in which the support member and the first substrate are joined includes a first area in which adhesion strength between the support member and the first substrate is relatively high and a second area in which adhesion strength between the support member and the first substrate is relatively low.

### BACKGROUND

### Field of the Disclosure

The present disclosure relates to a liquid ejection head.

### Description of the Related Art

Japanese Patent Laid-Open No. 2020-131627 has disclosed a liquid ejection head in which a cover member (support member), a nozzle board (first substrate), and an actuator substrate (second substrate) are bonded by an adhesive agent. According to the liquid ejection head of Japanese Patent Laid-Open No. 2020-131627, an adhesive agent is applied between the noise board and the cover member, and therefore, liquid (ink) is suppressed from invading from the bonding portion between the nozzle board and the cover member and the improvement of the liquid resistant property is implemented.

However, with the liquid ejection head as disclosed in Japanese Patent Laid-Open No. 2020-131627, in a case where the support member deforms, the stress having occurred due to the deformation propagates to the first substrate bonded to the support member. The surface on the opposite side of the bonding surface with the support member on the first substrate is bonded to the second substrate. Because of this, the stress having occurred due to the deformation of the support member acts to peel the first substrate off from the second substrate, and therefore, there is a possibility that the bonding portion in the liquid ejection head will break.

### SUMMARY

An object of the present disclosure is to provide a liquid ejection head whose resistance to the deformation of a support member has been improved.

The liquid ejection head according to the present disclosure includes: a first substrate having a first surface in which an ejection port configured to eject liquid is provided; a support member joined to the first surface of the first substrate and provided with an opening surrounding an area in which the ejection port in the first substrate is provided; and a second substrate joined to a second surface on the opposite side of the first surface of the first substrate, wherein an area in which the support member and the first substrate are joined includes a first area in which adhesion strength between the support member and the first substrate is relatively high and a second area in which adhesion strength between the support member and the first substrate is relatively low.

Further features of the present disclosure will become apparent from the following description of exemplary embodiments with reference to the attached drawings.

### BRIEF DESCRIPTION OF THE DRAWINGS

FIG. 1 is a diagram showing one example of a liquid ejection apparatus in one embodiment;

FIG. 2 is a perspective diagram showing a top surface of a liquid ejection head in one embodiment;

FIG. 3 is a perspective diagram showing a bottom face of a liquid ejection head in one embodiment;

FIG. 4 is a perspective diagram showing an ejection surface of a liquid ejection unit in one embodiment;

FIG. 5 is a perspective diagram showing a top surface of a liquid ejection unit in one embodiment;

FIG. 6 is an exploded perspective diagram of a liquid ejection unit in one embodiment;

FIG. 7 is a diagram explaining connection of each member configuring a liquid ejection unit in one embodiment;

FIG. 8 is a diagram showing a reference example;

FIG. 9A is an exploded perspective diagram for explaining a layer structure of a liquid ejection unit;

FIG. 9B is an exploded perspective diagram in a case where the layer structure of the liquid ejection unit is viewed from the side opposite to that in FIG. 9A;

FIG. 10 is an enlarged diagram of an area X in FIG. 7;

FIG. 11 is a perspective diagram showing a first substrate in one variant example;

FIG. 12 is an enlarged cross-sectional diagram of a liquid ejection unit in one variant example;

FIG. 13 is a perspective diagram showing a first substrate in one variant example;

FIG. 14 is an enlarged cross-sectional diagram of a liquid ejection unit in one variant example;

FIG. 15 is an exploded perspective diagram of feature portions in one embodiment;

FIG. 16 is an enlarged cross-sectional diagram of a liquid ejection unit in one embodiment;

FIG. 17 is a perspective diagram showing a first substrate in one variant example; and

FIG. 18 is an enlarged cross-sectional diagram of a liquid ejection unit in one variant example.

### DESCRIPTION OF THE EMBODIMENTS

### First Embodiment

### Liquid Ejection Apparatus 100

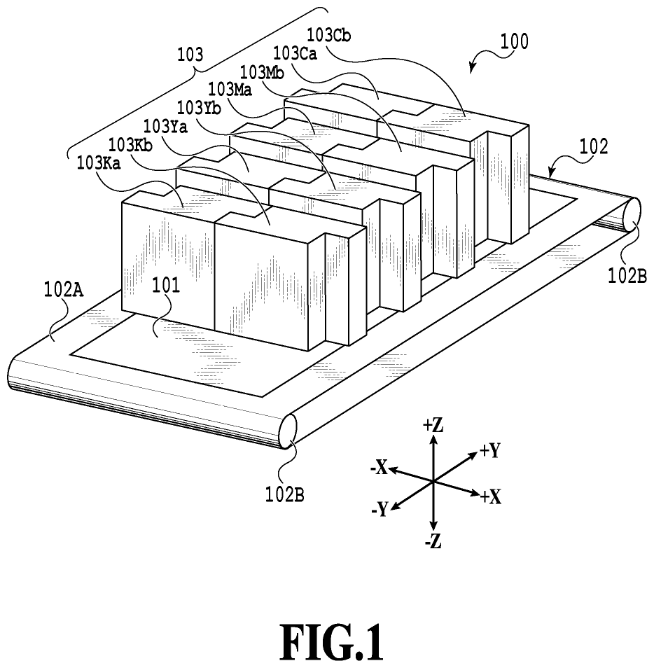

FIG. 1 is a diagram showing one example of a liquid ejection apparatus 100 that can be applied to the present embodiment.

First, the coordinate system shown in the drawings referred to in the present specification is explained. In the drawings referred to in the present specification, the −Y direction is the direction in which a printing medium 101 is conveyed and the +Y-direction is the direction toward the upstream side in the conveyance direction. The X-direction is the longitudinal direction (width direction) of a liquid ejection head 103 and in this case, the transverse direction (depth direction) of the liquid ejection head 103 is the direction along the Y-direction. The Z-direction is the height direction of the liquid ejection head 103. The liquid ejection head 103 prints an image on the printing medium 101 by ejecting liquid toward the −Z-direction.

In the present disclosure, “printing” means not only forming significant information (for example, a character, graphics or the like made visual so that a human being can percept them visually). “Printing” also means forming meaningless information. Further, in the present disclosure, “printing” also means widely forming an image, a pattern, a structure, a combination of these, or the like on the printing medium 101, or modifying a medium.

As shown in FIG. 1, the liquid ejection apparatus 100 comprises a conveyance unit 102 configured to convey the printing medium 101 in the conveyance direction, the liquid ejection head 103 configured to eject liquid to the printing medium 101, and a mounting unit (not shown schematically) for mounting the liquid ejection head 103 attachably and detachably.

In the present embodiment, as the printing medium 101, a cut sheet is used. The conveyance unit 102 has a conveyance belt 102A, a conveyance roller 102B configured to pivotally move the conveyance belt 102A, and the like. In detail, the conveyance unit 102 performs conveyance by adsorbing and holding the printing medium 101 to the conveyance belt 102A by a suction mechanism, not shown schematically, and pivotally moving the conveyance belt 102A. The printing medium 101 for which printing has been performed by the liquid ejection head 103 is peeled off from the conveyance belt 102A by a mechanism, not shown schematically, on the downstream side and discharged to a discharge unit (not shown schematically). The liquid ejection head 103 is a so-called page-wide type in which ejection ports are arrayed in accordance with the width (length in the X-direction) of the printing medium 101.

The liquid ejection head 103 includes liquid ejection heads 103C, 103M, 103Y, and 103K configured to eject cyan, magenta, yellow, and black liquids (for example, inks), respectively, in order from the upstream side in the conveyance direction of the printing medium 101. The liquid ejection head 103C configured to eject cyan ink is configured by joining a head unit 103Ca and a head unit 103Cb. Like the liquid ejection head 103C, the liquid ejection head 103M of magenta ink is configured by joining a head unit 103Ma and a head unit 103Mb. Further, the liquid ejection head 103Y of yellow ink is configured by joining a head unit 103Ya and a head unit 103Yb and the liquid ejection head 103K of black ink is configured by joining a head unit 103Ka and a head unit 103Kb. In the following, in a case where it is not necessary to particularly distinguish the head units 103Ca, 103Cb, 103Ma, 103Mb, 103Ya, 103Yb, 103Ka, and 103Kb from one another, they are simply called the head unit.

Each of the liquid ejection heads 103C, 103M, 103Y, and 103K has the same configuration. By the ink of the color corresponding to each of the liquid ejection heads 103C, 103M, 103Y, and 103K being supplied, the ink of each of the above-described colors is ejected. In the following, in a case where it is not necessary to particularly distinguish the liquid ejection heads 103C, 103M, 103Y, and 103K from one another, they are simply called the liquid ejection head 103. In the present embodiment, it is possible for the liquid ejection head 103 to perform full-color printing for the printing medium 101 that is conveyed by ejecting cyan, magenta, yellow, and black inks.

### Liquid Ejection Head 103

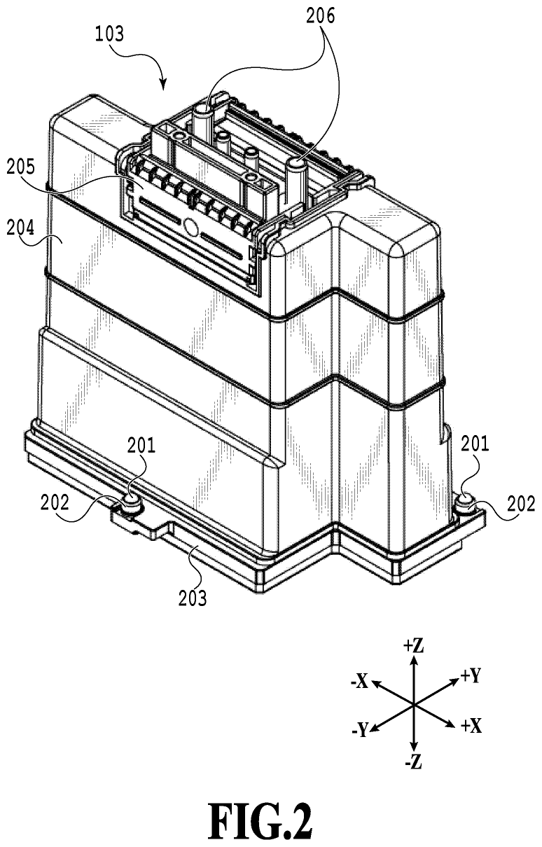

FIG. 2 is a perspective diagram showing the top surface of the liquid ejection head 103 in the present embodiment. In FIG. 2, one of the head units in the liquid ejection head 103 according to the present embodiment is shown, which is explained in FIG. 1.

As shown in FIG. 2, the liquid ejection head 103 comprises a reference member 201 having a function to determine a position with respect to the liquid ejection apparatus 100 (see FIG. 1). The reference member 201 is fixed to a common support member 203 by a reference fixing member 202. The liquid ejection head 103 comprises, as outer-casing portions, a first cover 204 and a second cover 205.

The first cover 204 covers and protects an electrical substrate (not shown schematically) and the like provided inside the liquid ejection head 103. The second cover 205 can be opened and closed and covers the periphery of an electrical connection terminal (not shown schematically) provided inside the liquid ejection head 103. At the top portion of the liquid ejection head 103, a liquid connection section 206 is provided. By the liquid connection section 206 being connected with a liquid supply system (not shown schematically) of the liquid ejection apparatus 100 (see FIG. 1), liquid is supplied to the inside of the liquid ejection head 103.

Inside the liquid ejection head 103, a support unit (not shown schematically) including the common support member 203, and the like are provided. The liquid flowing in from the side of the liquid ejection apparatus 100 through the liquid connection section 206 passes through a communication port (not shown schematically) and is supplied to a liquid supply member (not shown schematically) supported by the common support member 203.

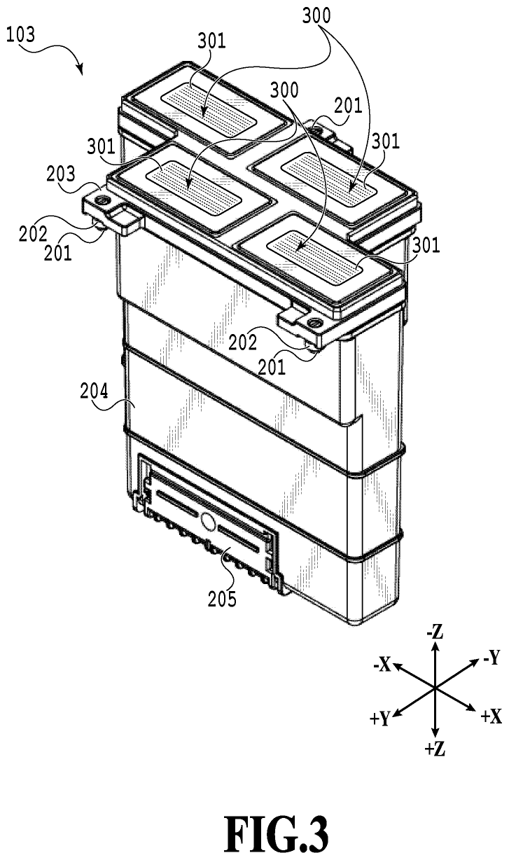

FIG. 3 is a perspective diagram showing the bottom face of the liquid ejection head 103 in the present embodiment.

As shown in FIG. 3, on the common support member 203, four liquid ejection units 300 capable of ejecting liquid are arranged in a staggered pattern. In each liquid ejection unit 300, a plurality of ejection ports 301 for ejecting liquid is formed.

In the common support member 203, three holes for inserting the reference fixing member 202 are provided. By the reference member 201 (see FIG. 2) being fixed to the reference fixing member 202 in a state where the position of the reference fixing member 202 is determined with respect to these holes, the liquid ejection head 103 is fixed to the liquid ejection apparatus 100. Inside the liquid ejection head 103, a liquid supply unit (not shown schematically) configured to supply liquid to the liquid ejection unit 300 via a support unit (not shown schematically), and the like are provided. Inside the liquid supply member (not shown schematically), a channel for distributing liquid to each liquid ejection unit 300 is formed.

### Liquid Ejection Unit 300

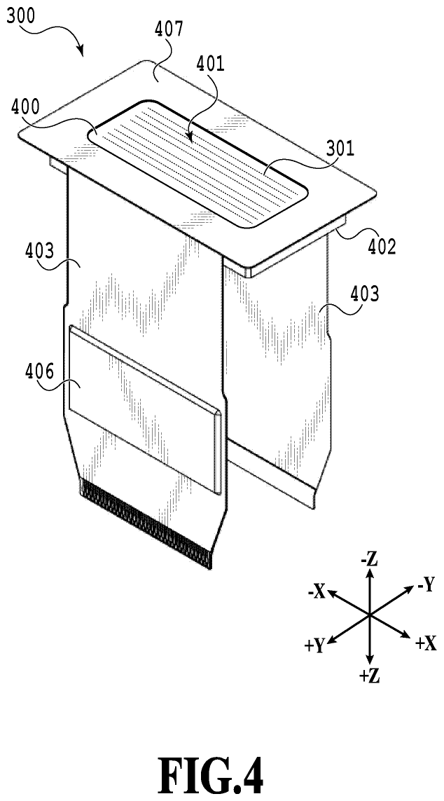

FIG. 4 is a perspective diagram showing an ejection surface 400 of the liquid ejection unit 300 in the present embodiment.

As shown in FIG. 4, the liquid ejection unit 300 comprises a first substrate 401 configured to eject liquid, a channel member 402 configured to supply liquid to the first substrate 401, and a flexible wiring substrate 403 electrically connected with the first substrate 401. The flexible wiring substrate 403 is provided with a drive circuit substrate 406 for driving an energy generation element (for example, piezoelectric element, not shown schematically) of the first substrate 401. The liquid ejection apparatus 100 (see FIG. 1) and the first substrate 401 are connected electrically via the flexible wiring substrate 403 and an electrical wiring substrate (not shown schematically). The liquid ejection unit 300 comprises a support member 407 joined to the ejection surface 400 of the first substrate 401.

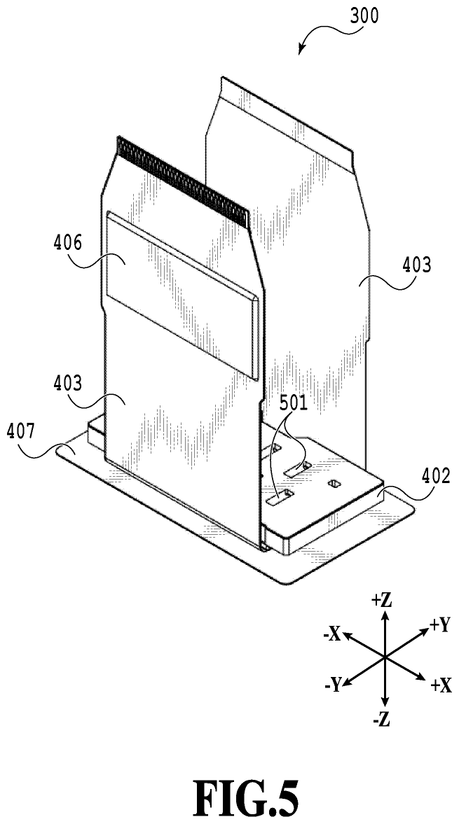

FIG. 5 is a perspective diagram showing the top surface of the liquid ejection unit 300 in the present embodiment.

As shown in FIG. 5, in the channel member 402, communication ports 501 are formed. Via this communication port 501, a channel of the channel member 402 and a channel formed in the common support member 203 are connected.

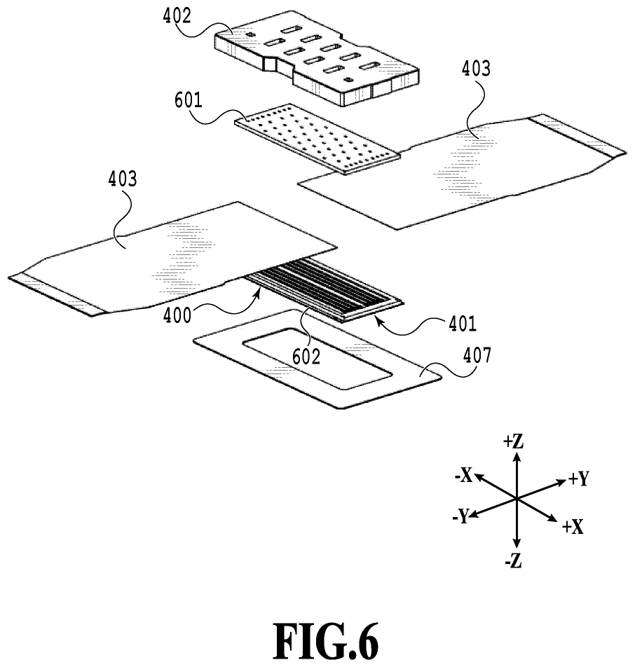

FIG. 6 is an exploded perspective diagram of the liquid ejection unit 300 in the present embodiment.

As shown in FIG. 6, between the first substrate 401 and the channel member 402, a channel conversion member 601 is sandwiched. On both end portions in the ±Y-directions of the first substrate 401, electrode portions (not shown schematically) are provided. By causing a first electrical connection section (not shown schematically) on the flexible wiring substrate 403 and the electrode portion on the first substrate 401 to come into contact with each other, the first substrate 401 and the flexible wiring substrate 403 are connected electrically. In order to suppress liquid from invading the electrical connection section and to reinforce the first substrate 401, the support member 407 is joined to the ejection surface 400 from the side in the −Z-direction.

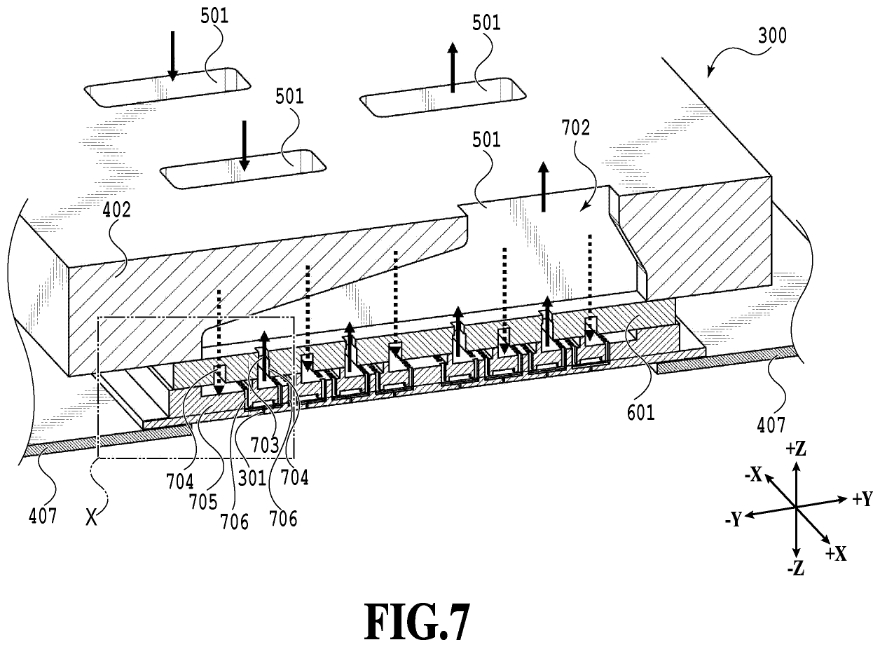

FIG. 7 is a diagram explaining the connection of each member configuring the liquid ejection unit 300 in the present embodiment.

As shown in FIG. 7, in the liquid ejection unit 300, the first substrate 401, a second substrate 705, the channel conversion member 601, and the channel member 402 are laminated in order from the side in the −Z-direction. Then, from the side (side in the −Z-direction) of the ejection surface 400 of the first substrate 401, the support member 407 is joined. In the first substrate 401, a plurality of the ejection ports 301 is formed. In the second substrate 705, individual channels 706 for supplying liquid to and collecting liquid from each ejection port 301 are formed. In the channel conversion member 601, common channels 704 for supplying liquid in common to a plurality of the individual channels 706 are formed. In the channel member 402, a plurality of the communication ports 501 and a liquid channel 702 configured to connect the communication port 501 and a plurality of the common channels 704 is formed. The communication port 501 is connected to a channel (not shown schematically) formed in the common support member 203 (not shown schematically in FIG. 7).

A plurality of the liquid channels 702 provided on the side in the −Y-direction of the channel member 402 in FIG. 7 and arranged along the X-direction is used for supplying liquid to the channel conversion member 601. On the other hand, a plurality of the liquid channels 702 provided on the side in the +Y-direction of the channel member 402 in FIG. 7 and arranged along the X-direction is used for collecting liquid from the channel conversion member 601.

In the channel for supplying liquid, the one liquid channel 702 is connected to a plurality of communication ports 703 formed in the channel conversion member 601. The liquid flowing in from each communication port 703 passes through the common channel 704 formed continuously from the communication port 703 and is supplied to the individual channel 706 in the second substrate 705. The liquid flowing into the individual channel 706 is supplied to the vicinity of the ejection port 301 in the first substrate 401.

In the channel for collecting liquid, a plurality of the communication ports 703 is connected to the one liquid channel 702. The liquid flowing in from each liquid channel 702 passes through the communication port 501 and is returned to a liquid supply system of the liquid ejection apparatus 100 (not shown schematically in FIG. 7). As described above, in the present embodiment, it is possible to circulate liquid via the path of the liquid ejection apparatus 100 (not shown schematically in FIG. 7) and the path of the liquid ejection head 103 (not shown schematically in FIG. 7).

The individual channel 706 of the second substrate 705 is provided with an energy generation element (for example, a piezoelectric element not shown schematically) configured to generate energy for ejecting liquid at the position corresponding to the ejection port 301. In a case of receiving a signal supplied via the flexible wiring substrate 403 (see FIG. 4), the energy generation element changes the volume of the individual channel 706 by the expansion of the energy generation element itself and ejects liquid droplets from the ejection port 301. In the present embodiment, as described above, liquid droplets are ejected from the ejection port 301 by the piezoelectric element driving.

Further, one end of the individual channel 706 connects with the common channel 704 on the supply side and the other end connects with the common channel 704 on the collection side. Because of this, the liquid in the vicinity of the ejection port 301 circulates and the ejection port 301 is supplied with fresh liquid stably irrespective of the presence/absence of ejection. For example, it is also possible to adjust the temperature of liquid to the temperature suitable to ejection by heating the liquid while circulating the liquid before ejecting the liquid.

### Explanation of Subject

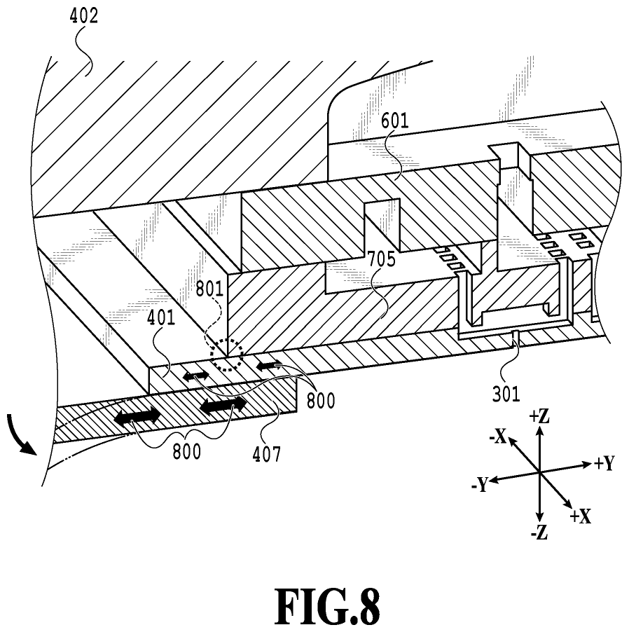

FIG. 8 is a diagram showing a reference example for explaining the subject in the present embodiment. To the same configurations as those of the present embodiment, the same names and symbols are attached and explanation thereof is omitted. In the following, a mechanism is explained in which the first substrate 401 deforms and peels off from the second substrate 705 due to the difference between the linear expansion coefficient of the first substrate 401 and the linear expansion coefficient of the support member 407.

In bonding the support member 407 to the first substrate 401, there is a case where, for example, a thermosetting-type adhesive agent is used in view of the liquid resistant property. The thermosetting-type adhesive agent is generally superior to the adhesive agent that is hardened at ambient temperature in the bonding strength, the heat resistance, the chemical resistance, the low linear expansion and the like. Because of that, for example, in a case where two channel members are bonded to each other, the thermosetting-type adhesive agent is used appropriately at the portion at which there is a possibility of a contact with liquid, the position that is heated in use, and the like.

For example, in the maintenance processing of the liquid ejection head 103, a suction cap (not shown schematically), a wiper (not shown schematically) and the like come into contact with the support member 407. Because of this, it is preferable for the material of the support member 407 to have a sufficient strength to an external force and the like and the break-resistant property. However, in a case where the material of the support member 407 is different from the material of the first substrate 401, there is a possibility that a large stress 800 occurs due to the difference between the linear expansion coefficients there of, which peels off the first substrate 401 from the second substrate 705 at a joined portion 801. In particular, in manufacturing the liquid ejection unit 300, a process to harden the thermosetting-type adhesive agent is included, and therefore, there is a possibility that the stress 800 occurs in the support member 407, the first substrate 401 and the like and deformation and cracks occur due to the head in this case.

Consequently, in the present embodiment, in order to suppress the influence of the above-described stress, the joined portion between the support member 407 and the first substrate 401 is allowed to have a feature.

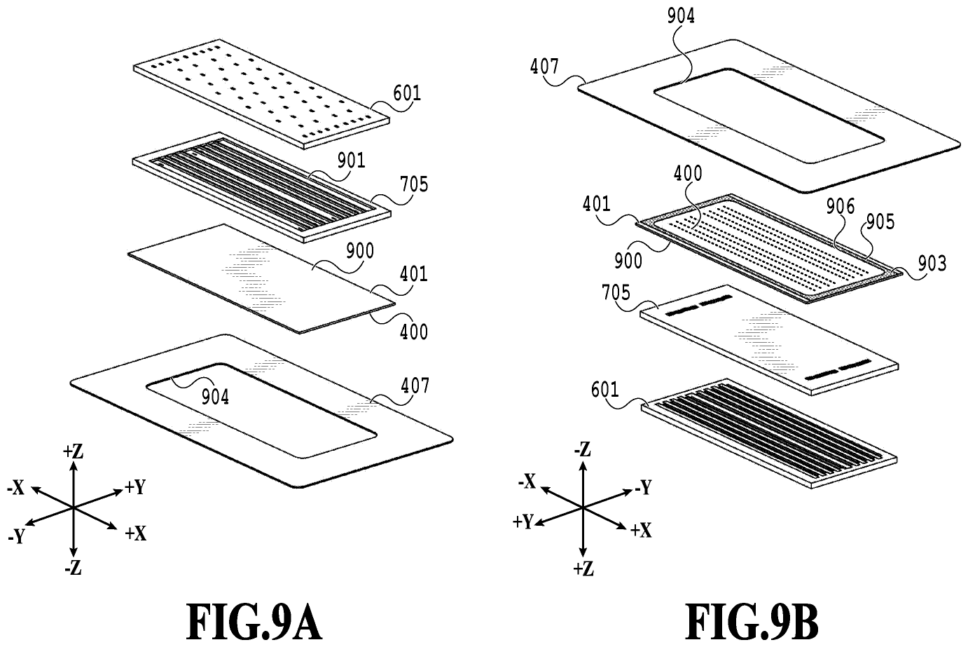

FIG. 9A is an exploded perspective diagram for explaining a layer structure of the liquid ejection unit 300.

As shown in FIG. 9A, the support member 407 is provided with an opening 904 surrounding an area in which the ejection port 301 (not shown schematically in FIG. 9A) in the first substrate 401 is provided in a state where the support member 407 and the first substrate 401 are bonded.

To the top surface (surface facing in the +Z-direction) of the support member 407, the ejection surface 400 of the first substrate 401 is bonded by an adhesive agent 903 (not shown schematically in FIG. 9A). As one example of the adhesive agent 903, there is a thermosetting-type adhesive agent.

To a first surface 900 (surface facing in the +Z-direction) of the first substrate 401, the bottom face (face facing in the −Z-direction) of the second substrate 705 is joined. To the top surface (surface facing in the +Z-direction) of the second substrate 705, the bottom face (face facing in the −Z-direction) of the channel conversion member 601 is jointed. In the second substrate 705, supply paths 901 for supplying liquid to the first substrate 401 are formed. By the bottom face of the second substrate 705 being joined to the first surface 900 of the first substrate 401, the individual channel 706 is formed.

FIG. 9B is an exploded perspective diagram showing the above-described layer structure from the side opposite to that in FIG. 9A. In FIG. 9B, a first projection line 905 indicates the outer circumference of the second substrate 705 in a case where the second substrate 705 is projected onto the ejection surface 400. On the other hand, a second projection line 906 indicates the inner circumference of the support member 407 in a case where the support member 407 is projected onto the ejection surface 400.

As shown in FIG. 9B, in the ejection surface 400 on the opposite side of the first surface 900 of the first substrate 401, a plurality of the ejection ports 301 configured to eject liquid is formed. The adhesive agent 903 is appended to the area surrounded by this first projection line 905 and the second projection line 906. That is, on the ejection surface 400, the adhesive agent 903 is appended to the overlapping area (hatching portion in FIG. 9B) in which the projection area in which the second substrate 705 is projected and the projection area in which the support member 407 is projected overlap. On the other hand, the adhesive agent 903 is not appended to the area (area at both ends in the ±Y-directions) in which the second substrate 705 is not projected but the support member 407 is projected.

Further, in the Y-direction, the second substrate 705 is smaller than the first substrate 401. That is, in a state where the first substrate 401 and the second substrate 705 are laminated, the end portion of the first substrate 401 in the Y-direction is in the state where the end portion protrudes from the second substrate 705.

It is possible to form the first substrate 401 by, for example, a silicon substrate. It is desirable for the linear expansion coefficient of the material of the support member 407 to be as close as possible to the linear expansion coefficient of the first substrate 401. For example, in a case where the first substrate 401 is a silicon substrate, it is desirable for the material of the support member 407 to include any one or more of titanium, nickel alloy, stainless, tungsten, molybdenum, ceramics and the like. It is desirable for the linear expansion coefficient of the support member 407 to be about five times or less the linear expansion coefficient of the first substrate 401.

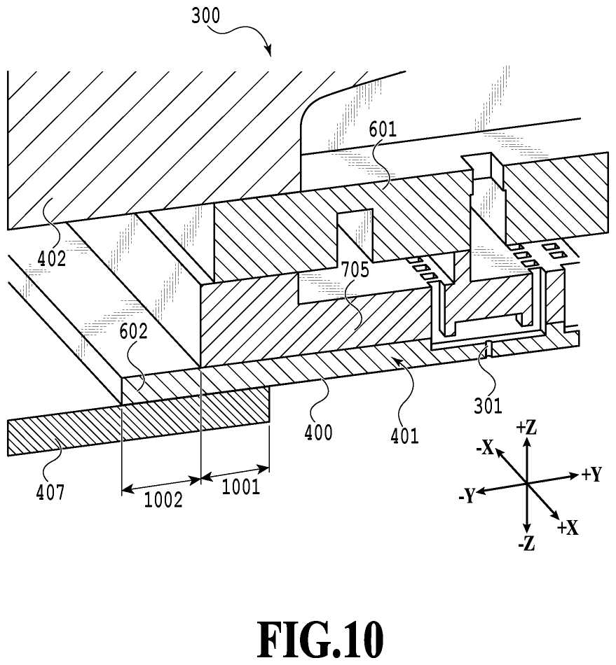

FIG. 10 is an enlarged diagram of an area X in FIG. 7.

As shown in FIG. 10, the liquid ejection unit 300 comprises the first substrate 401 having a first surface (in the present embodiment, the ejection surface 400) in which the ejection port 301 configured to eject liquid is provided. The liquid ejection unit 300 comprises the support member 407 joined to the ejection surface 400 of the first substrate 401 and provided with the opening 904 (see FIG. 9) surrounding the area in which the ejection port 301 in the first substrate 401 is provided. The liquid ejection unit 300 comprises the second substrate 705 joined to the second surface (in FIG. 10, the surface facing in the +Z-direction) on the opposite side of the ejection surface 400 of the first substrate 401. The area in which the support member 407 and the first substrate 401 are joined includes a first area 1001 in which the adhesion strength between the support member 407 and the first substrate 401 is relatively high and a second area 1002 in which the adhesion strength between the support member 407 and the first substrate 401 is relatively low.

In the state where the ejection surface 400 is viewed along the direction in which the support member 407, the first substrate 401, and the second substrate 705 are laminated, the first area 1001 includes an overlapping area in which the projection area in which the second substrate 705 is projected and the projection area in which the support member 407 is projected overlap. In the state where the ejection surface 400 is viewed along the direction in which the support member 407, the first substrate 401, and the second substrate 705 are laminated, the second area 1002 includes an area in which the second substrate 705 is not projected and the support member 407 is projected.

The width (magnitude in the Y-direction) of the second substrate 705 is smaller than the width of the first substrate 401. Because of this, in the state where the ejection surface 400 is viewed along the direction in which the support member 407, the first substrate 401, and the second substrate 705 are laminated, the projection area of the second substrate 705 for the first substrate 401 is smaller than the projection area of the first substrate 401.

In the present embodiment, the undersurface (in FIG. 10, the surface facing in the −Z-direction) of the second substrate 705 and the second surface (in FIG. 10, the surface facing in the +Z-direction) of the first substrate 401 are bonded by the adhesive agent 903 (not shown schematically in FIG. 10).

The liquid ejection unit 300 has the first area 1001 in which the support member 407, the first substrate 401, and the second substrate 705 overlap along the height direction (Z-direction). In the first area 1001 of the present embodiment, the support member 407 and the first substrate 401 are bonded by the adhesive agent 903 (not shown schematically in FIG. 10).

Further, the liquid ejection unit 300 has the second area 1002 in which the support member 407 and the first substrate 401 overlap along the height direction (Z-direction) but they do not overlap the second substrate 705.

In the present embodiment, the adhesive agent 903 (not shown schematically in FIG. 10) is not appended to the second area 1002. That is, in the second area 1002, the first substrate 401 is not fixed to the support member 407.

Because of this, the adhesion strength between the support member 407 and the first substrate 401 in the first area 1001 and the adhesion strength between the support member 407 and the first substrate 401 in the second area 1002 are different. Specifically, the adhesion strength between the support member 407 and the first substrate 401 in the second area 1002 is lower than the adhesion strength between the support member 407 and the first substrate 401 in the first area 1001.

For example, in a case where the support member 407 and the first substrate 401 are bonded by the thermosetting-type adhesive agent, in the process of hardening the thermosetting-type adhesive agent, there is a case where the temperature of the support member 407 becomes high because of the appended heat, and therefore, deformation, such as a warp, occurs.

However, according to the configuration of the present embodiment, even in a case where the support member 407 deforms somewhat, the first substrate 401 is not fixed to the support member 407 in the second area 1002, and therefore, the stress that accompanies the deformation of the support member 407 does not act on the first substrate 401 in the second area 1002. As described above, in the present embodiment, the area in which the adhesive agent 903 is interposed between the support member 407 and the first substrate 401 is limited only to part of the area (the first area 1001) in which the support member 407 and the first substrate 401 are laminated. Due to this, even in a case where the linear expansion coefficient of the first substrate 401 and the linear expansion coefficient of the support member 407 are different, it is possible to reduce the possibility that the first substrate 401 breaks and the possibility that the first substrate 401 peels off from the second substrate 705.

In the present embodiment, the thickness (length in the Z-direction) of the first substrate 401 is 0.3 mm or less. That is, the thickness of the area (thin-plate portion 602) protruding from the second substrate 705 on the first substrate 401 is also 0.3 mm or less. By thinning the first substrate 401, it is made possible to make small the stress itself that occurs in the thin-plate portion 602.

It is desirable for the adhesion agent that is used in the present embodiment to be the thermosetting type in order to improve the liquid resistant property and for the linear expansion coefficient to be as small as possible. Provided that the support member 407 and the first substrate 401 are not bonded completely in the second area 1002, it does not bring about any problem even in a case where the adhesive agent appended to the first area 1001 protrudes to the second area 1002. However, it is desirable for the protruding amount of the adhesive agent to be as small as possible.

As explained above, the liquid ejection head of the present embodiment has the first area in which the support member and the first substrate are fixed via the adhesive agent and the second area in which the support member and the first substrate are not fixed via the adhesive agent in the area in which the support member and the first substrate are laminated. In a case where the material of the first substrate and the material of the support member are different and the linear expansion coefficient of the first substrate and the linear expansion coefficient of the support member are different, the deformation amount of the first substrate and the deformation amount of the support member are different from each other.

Then, in the situation such as this, even in a case where the support member deforms by bonding the support member and the first substrate with the thermosetting-type adhesive agent, in the second area, the stress having occurred due to the deformation becomes hard to act.

As described above, in the present embodiment, the area exists in which the stress having occurred due to the deformation of the support member does not propagate to the first substrate laminated on the support member. As a result, the first substrate fixed so as to be sandwiched between the support member and the second substrate is suppressed from being pulled by the support member that is deforming and from being peeled off from the second substrate. According to this configuration, even in a case where the material of the first substrate and the material of the support member are different, it is made possible to use the thermosetting-type adhesive agent.

Consequently, according to the liquid ejection head of the present embodiment, it is possible to improve the resistance to the deformation of the support member.

### First Variant Example of the First Embodiment

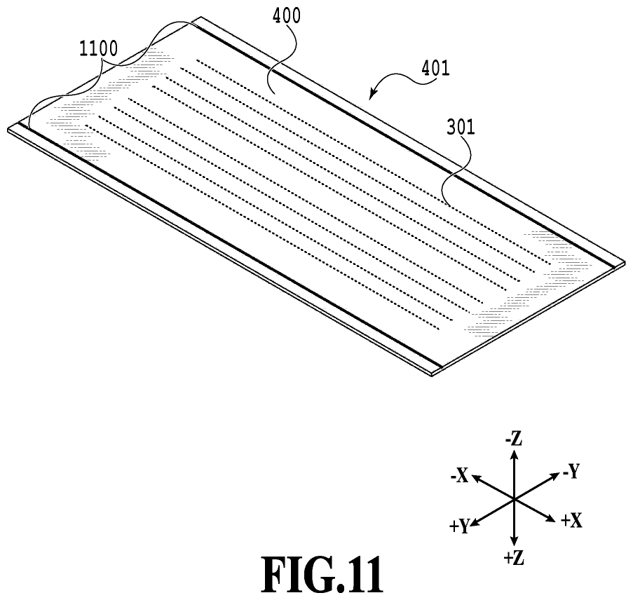

FIG. 11 is a perspective diagram showing a deformation example of the first substrate 401.

As shown in FIG. 11, at each of both end portions in the Y-direction of the ejection surface 400 of the first substrate 401, a groove portion 1100 is provided along the X-direction.

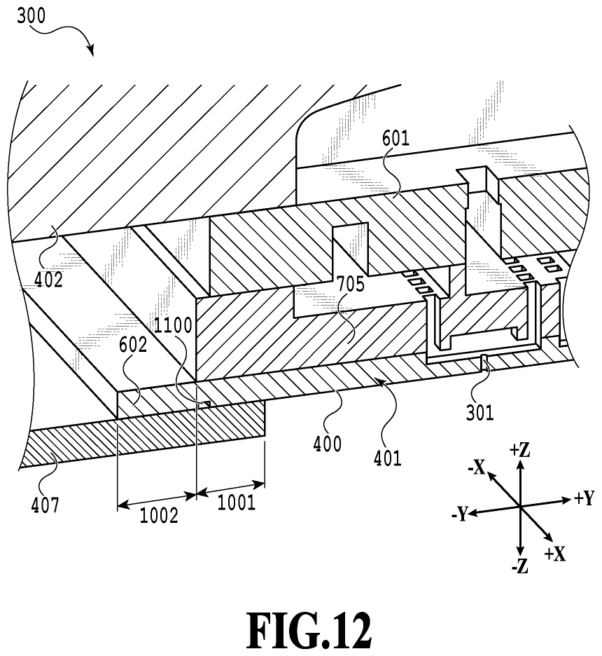

FIG. 12 is an enlarged cross-sectional diagram of the liquid ejection unit 300 in the present variant example.

As shown in FIG. 12, in the liquid ejection unit 300 of the present variant example, in the state where the support member 407, the first substrate 401, and the second substrate 705 are bonded, the groove portion 1100 is provided at the boundary portion with the second area 1002 in the first area 1001. According to this configuration, even in a case where the adhesive agent is appended by an amount exceeding the amount appropriate for bonding the first area 1001, it is possible to prevent the adhesive agent 903 (not shown schematically in FIG. 12) from flowing into the groove portion 1100, and therefore, to check the flow of the adhesive agent 903. Consequently, it is made to prevent the adhesive agent 903 protruding form the first area 1001 from reaching the second area 1002.

In the present variant example, the groove portion 1100 is provided in the first substrate 401, but as long as it is possible to cause the protruding adhesive agent 903 to flow into the groove portion 1100, the groove portion 1100 may be provided in the support member 407 or may be provided both in the first substrate 401 and in the support member 407.

As the results of causing the adhesive agent 903 to flow into the groove portion 1100, the adhesive agent 903 is made hard to reach the second area 1002, and therefore, it is made possible to prevent the support member 407 and the first substrate 401 from being fixed to each other. Consequently, even in a case where the support member 407 deforms, the stress having occurred due to the deformation is made hard to act on the second area 1002. That is, in the present variant example, it is also made possible to improve the resistance to the deformation of the support member 407.

### Second Variant Example of the First Embodiment

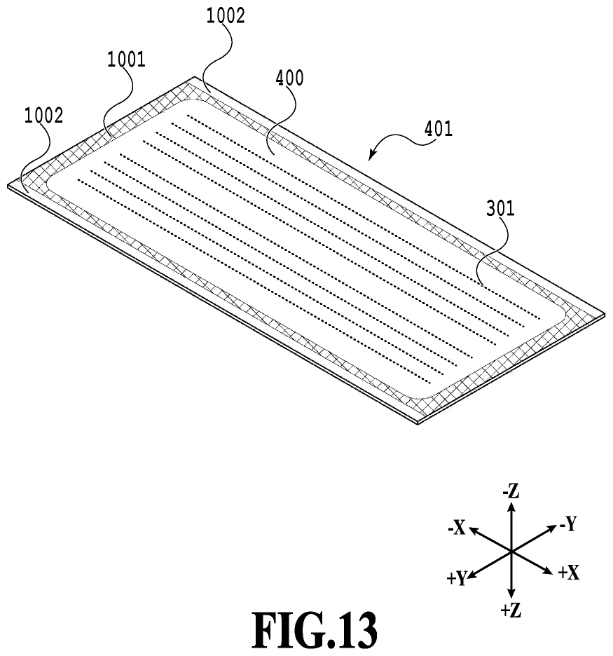

FIG. 13 is a perspective diagram of the first substrate 401 in the present variant example.

As shown in FIG. 13, on the first substrate 401 of the present variant example, part or all of the second area 1002 has been subjected to water-repellent treatment.

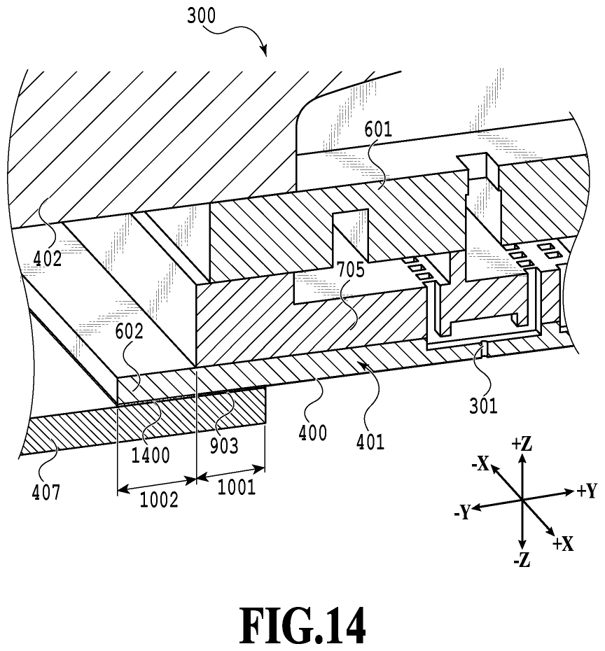

FIG. 14 is an enlarged cross-sectional diagram of the liquid ejection unit 300 in the present variant example.

As shown in FIG. 14, in the present variant example, in part or all of the second area 1002, a water repellent-treated portion 1400 having been subjected to a water-repellent treatment is included. In the water repellent-treated portion 1400, the support member 407 and the first substrate 401 become harder to come into close contact with each other than in the first embodiment. Because of this, even in a case where the support member 407 is heated and made to deform, the stress having occurred due to this deformation is hard to act on the thin-plate portion 602.

Further, even in a case where the adhesive agent 903 protrudes into the entire area of the second area 1002, in the second area 1002 including the water repellent-treated portion 1400, it is unlikely that the support member 407 is fixed completely to the first substrate 401.

Consequently, according to the liquid ejection head of the present variant example, even in a case where the adhesive agent protrudes into the second area, it is possible to improve the resistance to the deformation of the support member.

In the present variant example, the water repellent-treated portion 1400 is provided on the ejection surface 400 of the first substrate 401, but the position at which the water repellent-treated portion 1400 can be provided is not limited to the ejection surface 400. As long as it is possible to make the adhesion strength in the second area 1002 lower than the adhesion strength in the first area 1001, the water repellent-treated portion 1400 may be provided to the bonding surface with the ejection surface 400 in the support member 407 or both to the first substrate 401 and to the support member 407.

### Second Embodiment

In the following, a second embodiment in the technique of the present disclosure is explained with reference to the drawings. In the following explanation, to the configuration the same as or corresponding to that of the first embodiment, the same symbol is attached and at the same time, explanation thereof is omitted and different points are explained mainly. In the first embodiment, the second area is provided at the position outside the first area, but in the present embodiment, the second area is provided at the position inside the first area.

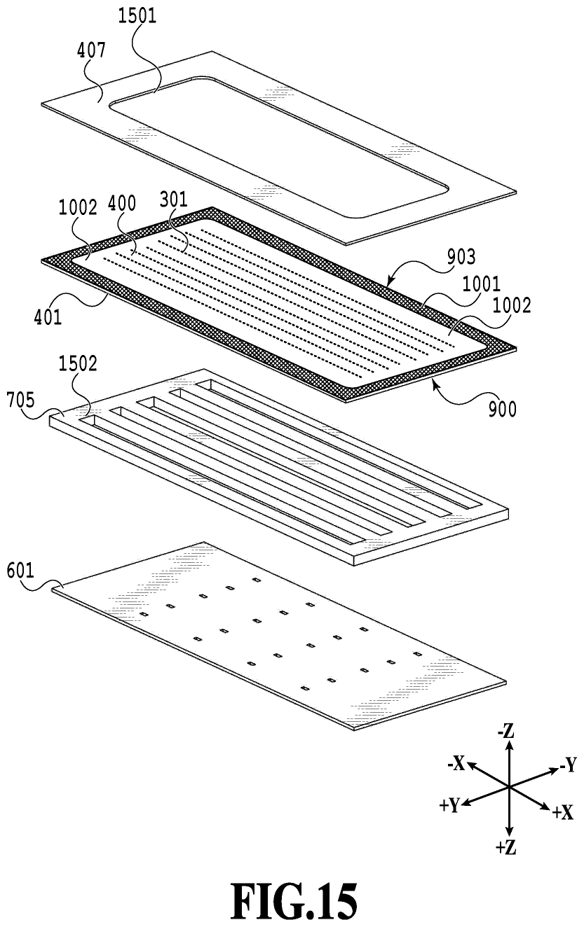

FIG. 15 is an exploded perspective diagram of the feature portion in the present embodiment.

As shown in FIG. 15, the shape of the channel formed in the second substrate 705 of the present embodiment is different from the shape of the channel formed in the second substrate of the first embodiment. In the second substrate 705 of the present embodiment, a plurality of channels 1502 extending in the X-direction and penetrating through the second substrate 705 in the Z-direction is arranged along the Y-direction.

To the bottom face (face facing in the −Z-direction) of the channel conversion member 601, the top surface (surface facing in the +Z-direction) of the second substrate 705 is bonded. To the bottom face (face facing in the −Z-direction) of the second substrate 705, the first surface 900 of the first substrate 401 is bonded. To the ejection surface 400 of the first substrate 401, the top surface (surface facing in the +Z-direction) of the support member 407 is bonded.

In the support member 407, an opening 1501 surrounding the area provided with the ejection port 301 in the first substrate 401 is provided in the state where the support member 407 and the first substrate 401 are bonded to each other. However, the opening 1501 of the present embodiment is smaller than the opening 904 (see FIG. 9A and FIG. 9B) of the first embodiment. In the state where the channel conversion member 601, the second substrate 705, the first substrate 401, and the support member 407 are bonded, a channel configured to connect the channel conversion member 601, the second substrate 705, and the first substrate 401 is formed.

In the present embodiment also, the adhesive agent 903 is appended to the first area 1001 in which the projection area of the second substrate 705 and the projection area of the support member 407 overlap each other in the state where the second substrate 705 and the support member 407 are projected onto the ejection surface 400 of the first substrate 401. On the other hand, the second substrate 705 in the present embodiment has the channel 1502, which is the through hole, and therefore, an area exists in which the support member 407 is projected but the second substrate 705 is not projected in the state where the second substrate 705 and the support member 407 are projected onto the ejection surface 400. In the present embodiment, this area is the second area 1002. To the second area 1002, the adhesive agent 903 is not appended. On the ejection surface 400 of the present embodiment, the second area 1002 is located at the position inside the first area 1001.

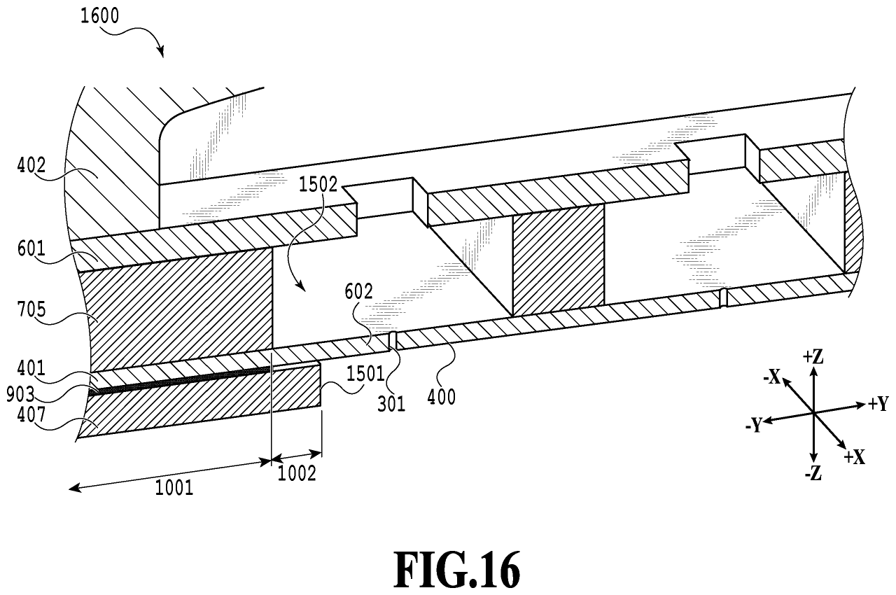

FIG. 16 is an enlarged cross-sectional diagram of a second liquid ejection unit 1600 in the present embodiment.

As shown in FIG. 16, on the ejection surface 400 of the present embodiment, the second area 1002 is located at the position corresponding to the channel 1502 in the second substrate 705 in the state where the channel conversion member 601, the second substrate 705, the first substrate 401, and the support member 407 are laminated. According to this configuration, the support member 407 is projected onto the position corresponding to the channel 1502 in the second substrate 705 but the second substrate 705 is not projected in the state where the second substrate 705, the first substrate 401, and the support member 407 are laminated.

As described above, in the present embodiment, the adhesive agent 903 is appended to the first area 1001 but the adhesive agent 903 is not appended to the second area 1002. Further, it may also be possible to perform the water-repellent treatment for the second area 1002. As long as it is possible to make the adhesion strength in the second area 1002 lower than the adhesion strength in the first area 1001, for example, it may also be possible to perform the water-repellent treatment for the bonding surface with the first substrate 401 in the support member 407.

According to the present embodiment, in the second area 1002, the support member 407 and the first substrate 401 are not bonded to each other. Because of this, even in a case where the support member 407 is heated and made to deform, the stress having occurred due to this deformation is hard to act on the thin-plate portion 602.

Consequently, with the liquid ejection head of the present embodiment, it is also possible to improve the resistance to the deformation of the support member.

### First Variant Example of the Second Embodiment

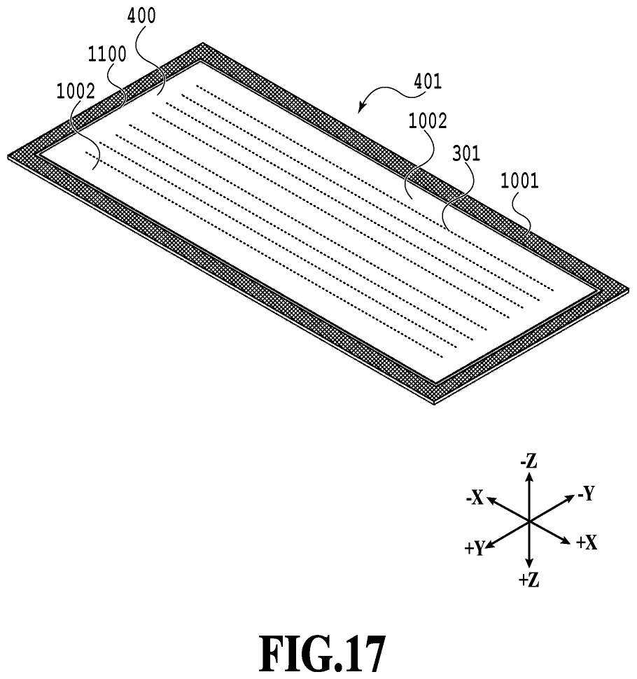

FIG. 17 is a perspective diagram of the first substrate 401 in the present variant example.

As shown in FIG. 17, on the ejection surface 400 of the present variant example, the first area 1001 is provided along the outer circumference. In the present variant example, along the inner circumference of the first area 1001, the groove portion 1100 is provided. Inside the groove portion 1100 of the present variant example, at each of both the end portions in the Y-direction of the ejection surface 400, the second area 1002 is provided along the X-direction. Further, part or all of the second area 1002 has been subjected to the water-repellent treatment.

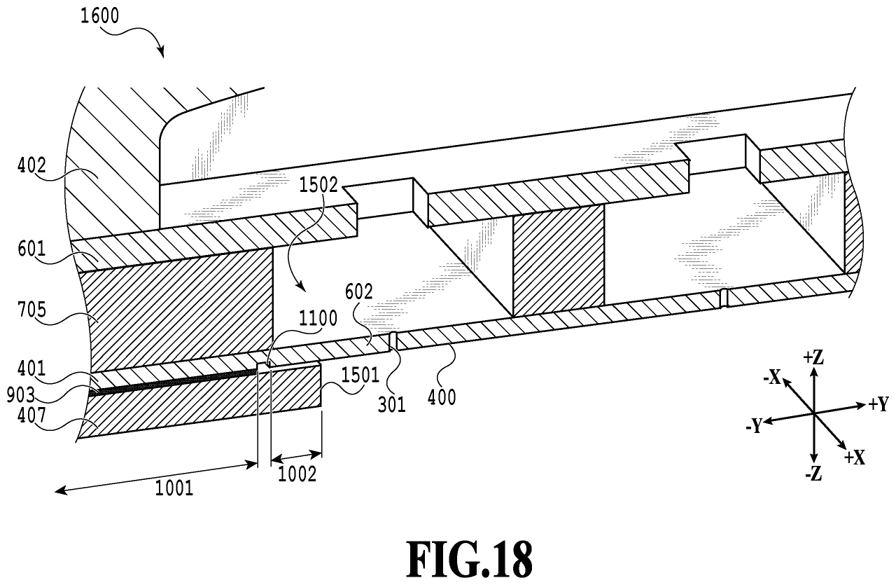

FIG. 18 is an enlarged cross-sectional diagram of the second liquid ejection unit 1600 in the present variant example.

As shown in FIG. 18, in the present variant example, the groove portion 1100 is provided at the boundary portion between the first area 1001 and the second area 1002. As described above, to the first area 1001, the adhesive agent 903 is appended. On the other hand, the second area 1002 has been subjected to the water-repellent treatment in the state where the adhesive agent 903 is not appended. In the first area 1001, the support member 407 and the first substrate 401 are fixed via the adhesive agent 903. On the other hand, in the second area 1002, the support member 407 and the first substrate 401 are not fixed.

According to this configuration, even in a case where the adhesive agent 903 protrudes from the first area 1001 and reaches the second area 1002 beyond the groove portion 1100, it is unlikely that the support member 407 is fixed to the first substrate 401 in the second area 1002 having been subjected to the water-repellent treatment. Because of this, even in a case where the support member 407 is heated and made to deform, the stress having occurred due to this deformation is hard to act on the thin-plate portion 602.

Consequently, according to the liquid ejection head of the present variant example, even in a case where the adhesive agent 903 protrudes into the second area 1002, it is possible to improve the resistance to the deformation of the support member.

As long as it is possible to prevent the support member 407 from being substantially fixed to the first substrate 401 in the second area 1002, the groove portion 1100 may be not provided in the first substrate 401 or the first substrate 401 may not be subjected to the water-repellent treatment. For example, the groove portion 1100 may be provided in the bonding surface with the first substrate 401 of the support member 407 and the water-repellent treatment may be performed.

Further, the unit for suppressing the protrusion of the adhesive agent, for partially reducing the adhesion strength and so on is not limited to the groove portion or the water-repellent treated unit and another configuration may be provided as long as it is possible to obtain the same effects. For example, a plurality of the groove portions may be provided along the direction in which the adhesive agent protrudes.

Further, in the present variant example, the groove portion extending in the X-direction is arranged, but it may also be possible to provide a plurality of concave portions for causing the excess adhesive agent to flow thereinto at a plurality of portions in the first area. After performing the water-repellent treatment only for the second area, the adhesive agent may be appended both to the first area and the second area. That is, in the area in which the first substrate 401 is laminated on the support member 407, the first area in which the support member 407 and the first substrate 401 are fixed relatively firmly and the second area in which they are not fixed firmly are provided. Due to this, it is made possible to provide a liquid ejection head whose resistance to deformation has been improved than ever while securing the sealing property of the bonding portion.

### Other Embodiments

In the above-described embodiments, explanation is given by supposing the case where the support member deforms due to the heat in a case where the thermosetting-type adhesive agent is hardened. As another example of the case where the support member deforms, there is an example in which the support member deforms due to the heat that is generated during the heating of ink for adjusting the temperature of the ink in a case where the liquid ejection head is used. As above, even in a case where there is a possibility that the support member deforms during the adjustment of the temperature of ink, as long as the support member is not fixed to the first substrate in the second area, it is possible to release the stress having occurred due to the deformation of the support member in the second area.

The liquid ejection head in the above embodiments ejects liquid by the drive of the piezoelectric element. In addition to this, it is possible to apply the technique of the present disclosure even to the thermal liquid ejection head configured to eject liquid by air bubbles generated by the heater element and liquid ejection heads adopting other various liquid ejection methods.

In the above embodiments, liquid such as ink is circulated between the tank and the liquid ejection head. In addition to this, it is possible to apply the technique of the present disclosure even to an aspect in which, for example, ink is not circulated and two tanks are provided on the upstream side and the downstream side of the liquid ejection head, and the ink within the pressure chamber is caused to flow by causing the ink to flow from one of the tanks to the other.

In the above embodiments, the so-called page-wide type liquid ejection head is used, but it is also possible to apply the technique of the present disclosure to a liquid ejection head configured to perform printing while performing a scan. That is, it is also possible to apply the technique of the present disclosure to the so-called serial type liquid ejection head.

In the above embodiments, as the printing medium, a cut sheet is used. Other than the cut sheet, it is possible to use printing media of various materials and in various aspects, for example, such as roll paper, cloth, optical disc label surface, plastic sheet, OHP sheet, and envelope.

In the above embodiments, ink is used as liquid, but the liquid that can be used for the technique of the present disclosure is not limited to ink. Other than ink, as liquid, it is possible to use various printing liquids including a processing liquid and the like that are used for the purpose of improving the fixing property of ink in a printing medium, reducing the unevenness in gloss, and improving the scratch resistance.

According to the liquid ejection head of the present disclosure, it is possible to improve the resistance to the deformation of a support member.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-198338, filed Nov. 22, 2023 which are hereby incorporated by reference wherein in its entirety.

What is claimed is:

1. A liquid ejection head comprising:
a first substrate having a first surface in which an ejection port configured to eject liquid is provided;
a support member joined to the first surface of the first substrate and provided with an opening surrounding an area in which the ejection port in the first substrate is provided; and
a second substrate joined to a second surface on the opposite side of the first surface of the first substrate, wherein
an area in which the support member and the first substrate are joined includes a first area in which adhesion strength between the support member and the first substrate is relatively high and a second area in which adhesion strength between the support member and the first substrate is relatively low.

2. The liquid ejection head according to claim 1, wherein
in a state where the first surface is viewed along a direction in which the support member, the first substrate, and the second substrate are laminated, the first area includes an overlapping area in which a projection area in which the second substrate is projected and a projection area in which the support member is projected overlap and the second area includes an area in which the second substrate is not projected but the support member is projected.

3. The liquid ejection head according to claim 1, wherein
a linear expansion coefficient of the first substrate is lower than a linear expansion coefficient of the support member.

4. The liquid ejection head according to claim 3, wherein
the linear expansion coefficient of the first substrate is five times or less the linear expansion coefficient of the support member.

5. The liquid ejection head according to claim 4, wherein
the first substrate includes silicon and
the support member includes any one or more of titanium, nickel alloy, stainless, tungsten, molybdenum, and ceramics.

6. The liquid ejection head according to claim 1, wherein
in a state where the first surface is viewed along a direction in which the support member, the first substrate, and the second substrate are laminated, a projection area of the second substrate for the first substrate is smaller than a projection area of the first substrate.

7. The liquid ejection head according to claim 1, wherein
to the first area, an adhesive agent is appended and
to the second area, an adhesive agent is not appended.

8. The liquid ejection head according to claim 7, wherein
the adhesive agent is a thermosetting-type adhesive agent.

9. The liquid ejection head according to claim 7, wherein
at a boundary between the first area and the second area, a groove portion is provided.

10. The liquid ejection head according to claim 1, wherein
part or all of the second area has been subjected to water-repellent treatment.

11. The liquid ejection head according to claim 1, wherein
the thickness of part or all of the first substrate is 0.3 mm or less.

12. The liquid ejection head according to claim 1, wherein
the second substrate is provided with an individual channel for supplying liquid to each of the ejection ports and an energy generation element configured to generate energy for ejecting liquid from the ejection port.

13. A liquid ejection apparatus comprising:
a liquid ejection head comprising a first substrate having a first surface in which an ejection port configured to eject liquid is provided, a support member joined to the first surface of the first substrate and provided with an opening surrounding an area in which the ejection port in the first substrate is provided, and a second substrate joined to a second surface on the opposite side of the first surface of the first substrate; and
a mounting unit for mounting the liquid ejection head, wherein
an area in which the support member and the first substrate are joined includes a first area in which adhesion strength between the support member and the first substrate is relatively high and a second area in which adhesion strength between the support member and the first substrate is relatively low.
